(19) United States
(12) Patent Application Publication
(10) Pub. No.: US 2024/0007582 A1
(43) Pub. Date: Jan. 4, 2024

(54) USING DISPLAY ILLUMINATION TO IMPROVE FACIAL IMAGE QUALITY FOR LOW LIGHT VIDEO CONFERENCE

(71) Applicant: ATI Technologies ULC, Markham (CA)

(72) Inventor: Tung Chuen Kwong, Markham (CA)

(21) Appl. No.: 17/853,349

(22) Filed: Jun. 29, 2022

(51) Int. Cl. H04N 5/262

(52) U.S. Cl. CPC H04N 5/262

(57) ABSTRACT

A system and method for automatically adjusting light conditions in a video conference environment are disclosed. A video conferencing system includes a camera to capture an image of a video conference participant and a computing device to evaluate and compensate for lighting conditions. A display device enables the participant to view other video conference participants. Video data captured by the camera is conveyed to the computing device. The computing device is configured to evaluate lighting conditions of a captured image and evaluate the lighting conditions for possible adjustment. Responsive to an evaluation of the lighting conditions, the computing device is configured to automatically generate a light border for display on the display device. The light border is composited with window display data received from a video conference application. The light border generated by the computing device is generated to create an amount of light that compensates for low light, or uneven light, conditions.

### BACKGROUND

### Description of the Relevant Art

In the last several years, video conferencing has become increasingly common. This is due to a variety of reasons including the ready availability and lower cost of webcams, increasing numbers of people working from home, work forces that are widely distributed geographically, and otherwise. One problem that often arises when video conferencing is used is that lighting conditions may not be optimal. Often times the camera may be set up in a home office, bedroom, or otherwise, where the lighting is not designed for optimal display during the video conference. Consequently, lighting of a participant in the conference may be too dim for others to clearly see the individual, may be uneven, colors displayed by a display device may be uneven, and so on.

In some cases low light conditions may be compensated for by an increased camera sensor gain. However, this approach results in increased noise. While it may be possible to perform some post-processing noise reduction techniques to compensate for the noise, this requires the expense of computing resources.

In view of the above, systems and methods for improving the lighting conditions during video conferences are desired.

### BRIEF DESCRIPTION OF THE DRAWINGS

FIG. 1 illustrates a video conferencing image with low light conditions.

FIG. 2 illustrates an example of a light border to compensate for low light conditions.

FIG. 3 illustrated an example of uneven lighting conditions.

FIG. 4 illustrates generation of a light border for uneven lighting conditions.

FIG. 5 is a generalized diagram of system for generating a light border for a display device.

FIG. 6 is a generalized diagram of a method for generating a light border for a display device.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for automatically adjusting light conditions in a video conference are disclosed. A video conferencing system includes a camera to capture an image of a video conference participant and a computing device to evaluate and compensate for lighting conditions. A display device enables the participant to view other video conference participants. Video data captured by the camera is conveyed to the computing device. The computing device is configured to evaluate lighting conditions of a captured image and evaluate the lighting conditions for possible adjustment. Responsive to an evaluation of the lighting conditions of the video conference environment, the computing device is configured to automatically generate a “light border” for display on the display device. As used herein, a “light border” is one or more pixels generated for display on a display device that increase an amount of light produced by the display device. As will be described, the light border is generated in ways that improve or otherwise change the lighting conditions of a subject captured by a camera. Based on an evaluation of captured image data, an illumination map is created that indicates relative light levels of the image data. In various implementations, the illumination map can take any of a variety of forms, including a table(s), vector(s), matrices, or otherwise. The light border generated by the computing device is generated to create an amount of light that compensates for low light conditions. The light border is also created to compensate for uneven lighting and to adjust for color. The light border is composited with window display data received from a video conference application to form a composite image which is conveyed for display. The camera captures the newly composited image with the light border which is fed back to the computing device. In response, a new illumination map is created. The new illumination map reflects changes in light levels of the image captured by the camera. For example, pixel values that indicate relative brightness and/or color may have changed. By comparing these values across in image as indicated by the illumination map, the computing device is configured to determine that some values should be increased or decreased.

As one example, a face may be identified in the captured image data. An illumination map (or table or other indication) indicates that the left side of the face is illuminated with values in the range 20-30 (arbitrary values are used to illustrate). It is determined that the right side of the face is illuminated with values in the range 60-70. In response, a light border that increases the light levels on the left side of the face is generated in an effort to even out the lighting across the face. A light border is then generated the produces more light to the left side of the face than the right side of the face and a new image is captured. On review of the newly captured image data, it is determined the left side of the face is now illuminated with values in the range 50-60 and the right side is illuminated with values that remain in the range 60-70. In this case, the values increased by 30 on the left side of the face. In response, a new light border may be generated to increase lighting to the left side of the face further. However, a smaller increase in light produced is needed and a smaller increase in the size or brightness of the border to the left side of the face is generated. This process of capturing an image, evaluating light levels, and generating/adjusting a light border can be repeated indefinitely. Other embodiments are disclosed and will be appreciated from the following description.

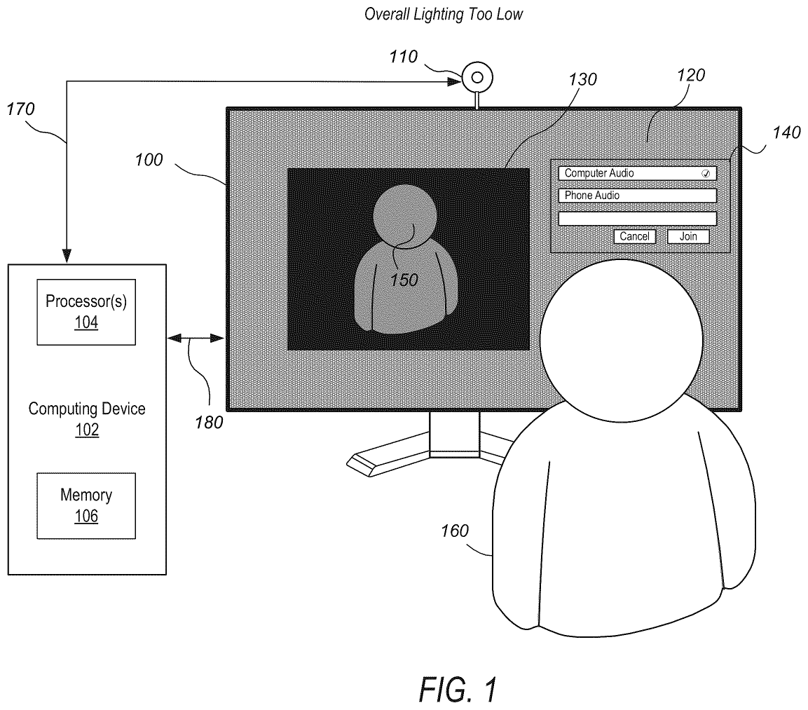

FIG. 1 illustrates one implementation of video conferencing apparatus. In the example shown, a user 160 is positioned in front of a camera 110 (e.g., a webcam) atop, or integrated with, a display device 100. A computing device 102 comprising one or more processors 104 and memory 106 is shown coupled to the display device 100 and the camera 110. In various implementations, the computing device 102 is a desktop computer, laptop computer, gaming console, or otherwise. In this example, computing device 102 is configured to receive video and/or other image data 170 captured by camera 110. As used herein, the term “video” includes video and/or still image data. In addition, computing device 102 is configured to convey video data for display on display device 100 via path 180. In various implementations, path 180 is any of a wired or wireless interconnect configured to convey video and/or image data (e.g., DisplayPort, HDMI, etc.).

In the example of FIG. 1, an image 120 is generated on the display device 100. The generated image includes video 130 corresponding to video data captured by camera 110. In this example, for purpose of discussion, the user 160 is viewing a video image 150 of themself. Also illustrated in FIG. 1 is a background image 120 not generated by the video camera 110, and various options 140 available for the user 160 to adjust aspects of the video conferences session (e.g., whether audio will be via computer, phone, etc.). Numerous such options are possible and are contemplated, included options to adjust (for either the captured video data 150 or background image 120) brightness, contrast, color, and so on.

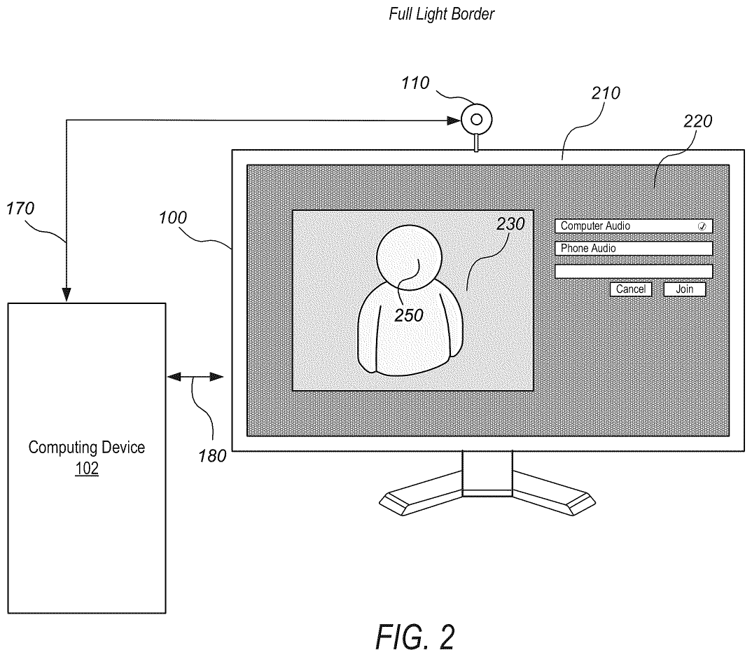

As shown in FIG. 1, the overall lighting for the captured video image 150 is too low. Consequently, it is too dark to clearly make out features in the image 150 in a satisfactory way. This scenario often arises due to the environment of the user 160 having too little ambient light in areas captured by the camera. Of particular interest during a video conference is having adequate lighting of the person 160 participating so that their image 150 is clearly viewable and recognizable. In various implementations as described herein, computing device 102 is configured to automatically adjust lighting conditions on, and in the area surrounding, the user 160 in order to increase the lighting of the captured video 150. FIG. 2 illustrates such an implementation. In this figure, various elements are reproduced from FIG. 1 and are like numbered. The user 160 in this case is not shown for ease of illustration.

In the implementation shown, the computing device 102 is configured to automatically detect (via a suitable combination of hardware and/or software) that lighting levels of the captures video 150 are too low. In some implementations, the computing device 102 is configured to detect a face (or person) in the image data and evaluate lighting on the subject's (i.e., person 160) face. As illustrated in FIG. 1, the lighting is too low. Computing device 102 is configured to automatically determine the lighting on the subject's face and automatically generate a “light” border 210 around the video conference image 230. In this example, the border 210 is generated around the background image 222. In other words, part of the background image 220 generated on the display device 100 is a border of pixels with a given width. In order to generate an increased amount of light, the computing device 102 generates the border 210 whose pixels have a brightness and color that increases the amount of light that falls on the subject (i.e., the user 160). For example, in an implementation the border is generated with white pixels with a given brightness. Other implementations use other colors as well. Responsive to generating the border 210, an increased amount of light falls on the subject and new video image data 250 is captured by the camera.

As shown in FIG. 2, the new image data 250 is shown to be brighter/lighter than that that was shown in FIG. 1 due to the light generated by the border 210. In response to capturing the new image, the camera 110 conveys the newly captured image to the computing device 102. The computing device 102 reevaluates the new image to determine if the lighting and/or other visual aspects of the image 250 are acceptable. If further adjustments to the lighting are deemed necessary, the computing device 102 is configured to increase or decrease the light generated by the border 210. In order to increase the amount of light generated by the border, the computing device 102 is configured to increase the brightness of the pixels and/or change the color. For example, if the first border 210 generated had pixels set to a brightness level of 50%, the computing device 102 may increase the brightness level to a higher level (e.g., 55%, 60%, etc.). Conversely, if the lighting is deemed too bright, the computing device is configured to generate the border 210 with a reduced pixel brightness. In other implementations, the computing device is configured to change a width of the border in addition to (or as an alternative to) changing the pixel brightness and color. For example, if it is determined that increased lighting is needed, the width of the light border can be expanded. If it is determined that decreased lighting is needed, the width of the light border can be reduced/narrowed. Changing the brightness level results in the capture of an image 250 with an altered lighting level which is again evaluated by the computing device 102. In this manner, a feedback loop is created such that the computing device 102 continually reevaluates and adjusts the light border 210 as needed in response to the newly captured image data. In some implementations, the process continues indefinitely until stopped or turned off by a user. For example, in one implementation, a user 160 performs an initial setup to establish a desired lighting level and the disables or turns off the continuous feedback and reevaluation process in order to reduce computation performed by the computing device 102.

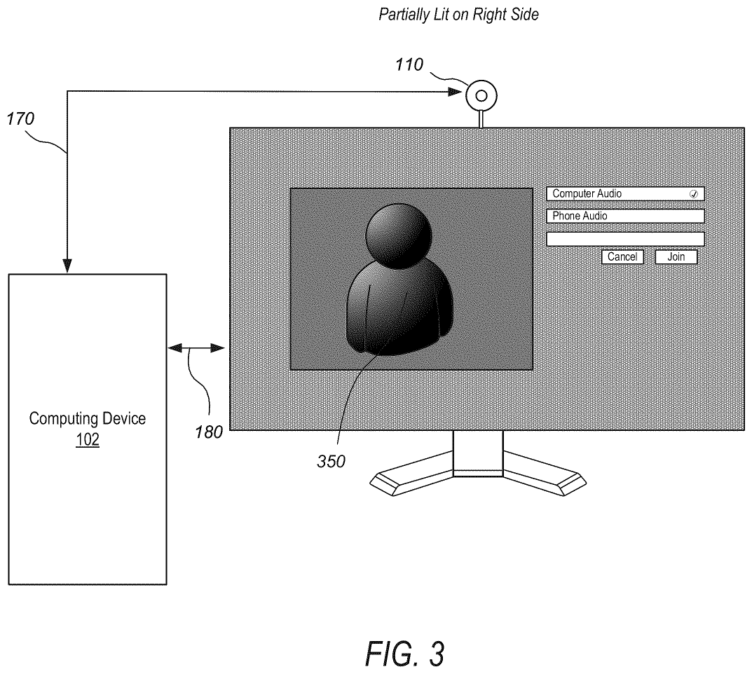

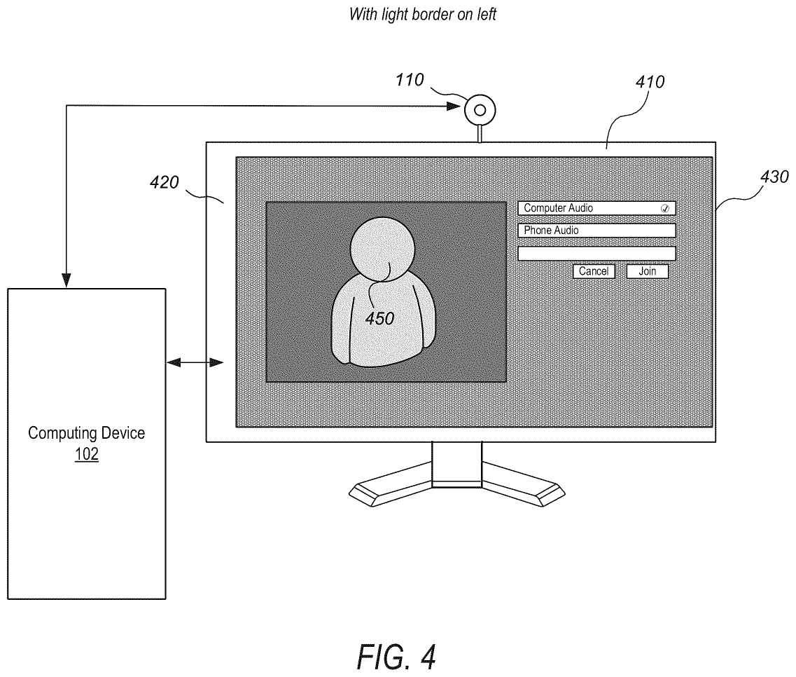

Turning now to FIG. 3, an example illustrating uneven lighting is shown. In this example, the captured image 350 is shown to have more light on the left side (the left side of image 350) than the right. This could be due to have a light source (e.g., a window, lamp, etc.) on one side of the user (e.g., on the right side of the user in this example). FIG. 4 illustrates how uneven lighting is corrected. In this example, computing device 102 detects that one side of the image is more brightly lit than the other which results in uneven lighting of the subject. In order to adjust the lighting on the subject, the computing device 102 automatically creates a light border 410 with increased light on the left as compared to the right. For example, the left side 420 of the border is wider than the right side 430 which is narrow in comparison. In this manner, a greater amount of light is generated on the left side of the display than the right.

As an alternative to using different border widths, different pixel brightness can be used to create a difference between one side or portion of a display and another. In various implementations, combinations of width/size, pixel brightness, and pixel color are used to change lighting conditions in the presence of a user 160. For example, in some implementations, the brightness and color of the border 410 may vary (i.e., have gradations of brightness, asymmetric light levels/brightness, color, etc.) at different locations. Additionally, in various implementations, light border adjustments are dynamically made to adjust for sudden changes in light levels (i.e., to even out the sudden changes). In this manner, a more even lighting of the subject is possible. As discussed above, by capturing the newly lit image and feeding the data back to the computing device 102, the image lighting can be reevaluated and readjusted if needed one or more times.

It is noted that while lighting is generally discussed herein, color tone, hues, and other features can be adjusted for by adjusting the brightness and color of the border(s) created. For example, in addition to evaluating brightness levels across an image 450, the computing device may also be configured to evaluate flesh tones (or other captured colors/tones) for a more natural appearance and other conditions. In some implementations, such tones are adjusted for by generation of a suitable light border. For example, during a setup procedure, a user may select a setting/adjustment that indicates a desired flesh tone as captured by the camera 110. In response, the computing device 102 saves this setting/adjustment and evaluates captured image data in view of the settings and makes adjustments as needed with the generated border 410 to better approximate the desired flesh tone in the captured image 450. For example, color balance, exposure, and other image features may be adjusted for using the automatically generated border(s). Numerous such implementations are possible and are contemplated.

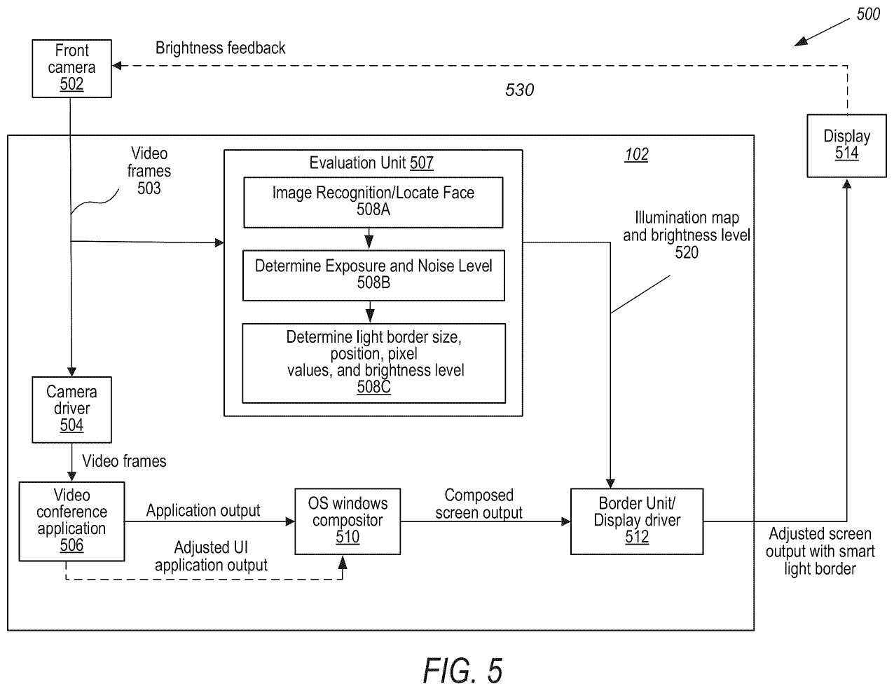

Turning now to FIG. 5, one implementation of a system 500 configured to automatically adjust lighting conditions for a subject image is shown. System 500 includes computing device 102, a camera 502, and display device 514. Computing device 102 is shown to include various elements such as a camera driver 504, video conference application 506, evaluation unit 507, operating system window compositor 510 and border generation unit/display driver 512. As used herein, the term “unit” refers to a circuit or circuitry configured to perform the functions described. In some implementations, the circuitry is special purpose circuitry configured to perform the particular functions described. In other implementations, the circuit or circuitry is general purpose in whole or in part and is configured to execute software to perform the functions described. All such implementations are possible and are contemplated. While border generation unit (or “border unit”) and display driver 512 are shown as a combined single entity, in various implementations they are separate and not combined. In the illustrated implementation, the camera 502 captures video image data 503 which is then conveyed to a camera driver 504. Additionally, the captured image data 502 is conveyed to elements (e.g., software components) configured to perform various function. It is noted that while reference is made to multiple components, in various implementations all the described features are performed by a single component and/or are performed by hardware elements as well. In the example shown, an image recognition module 508A is configured to identify a face in captured image data by default. In some implementations, the item to be focused upon is selectable by the user. For example, if the user wishes the subject of the image to be something other than their face, they an select such a subject using a mouse, touch screen, or otherwise. Subsequently, adjustments to the lighting of the selected subject will be performed.

In addition to identifying a face, exposure and noise levels in the captured image data are determined 508B. For example, exposure and noise levels corresponding to the subject, in particular, are determined. Additionally, an illumination map is generated that indicates relative lighting for various portions of the captured image. Based on the exposure and noise levels, a light border is automatically generated to compensate for undesirable light levels (e.g., too much or not enough, uneven, etc.) by a module 508C. Depending on the determined exposure, noise, lighting, and so on, values/parameters for the border are generated with a given size, position, pixel values, and brightness level. Parameters describing the border and the illumination map 520 are conveyed to border unit/display driver 512. Border unit/display driver 512 also receives window image data generated by the video conference application 506 and composites the light border with the window image data to form a final image for conveyance to the display device. This window image data may include a background, a video image, setting panel, or otherwise. Display driver 512 then composes the display data to include the window image data provided by the application 506 and the light border defined by the data 520. The final image is then conveyed for display on the display device 514. As described above, the camera captures the new image data with the new lighting by the light border. The new image data 503 is then reevaluated and further adjustments to the light border are made as needed.

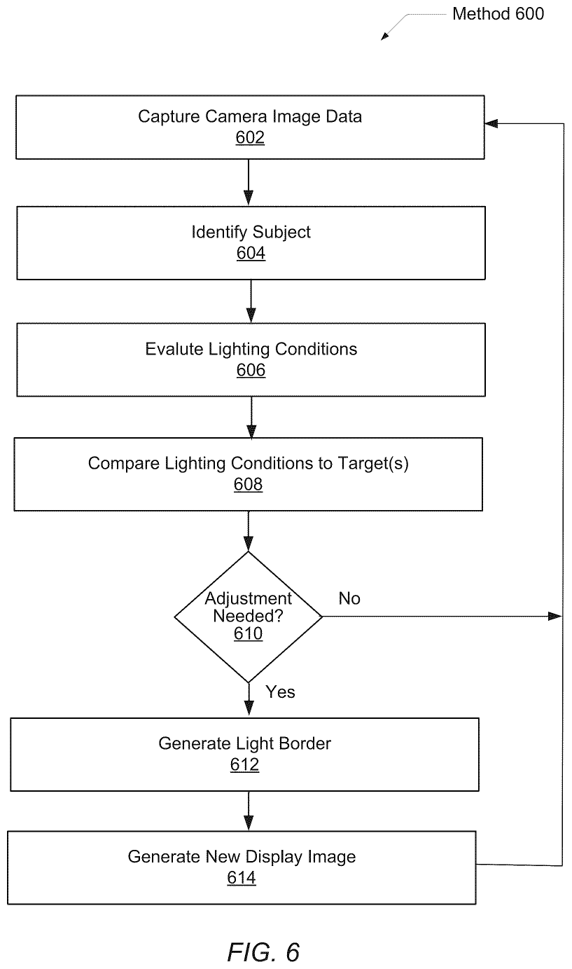

Referring to FIG. 6, a method 600 for automatically adjusting lighting for a video conference is illustrated. In the illustrated method, image data is captured by a camera device (602) which is then conveyed to a computing device. The computing device includes hardware and/or software configured to perform image evaluation functions and generation of display data. In various implementations, the computing device is configured to execute video conferencing software, camera driver software, and display driver software as discussed in relation to FIG. 5. The captured camera image data (e.g., video frames and/or still image data) is processed to identify a subject 604 in the captured image. In some implementations, the image data is processed to identify a face(s) as the subject by default. In other implementations, a user selects a subject, other than a face, for use as the subject. In yet other implementations, the entire captured image may be used as the subject.

Having identified a subject, lighting conditions of the subject are evaluated (606). For example, exposure and noise levels of the image data are determined. In the case where a face has been identified and is the subject, lighting conditions in relation to the face in the captured image data are evaluated. In various implementations, evaluating lighting conditions includes evaluation exposure, noise levels, color balance, as well as other image data characteristics. Based at least in part on the evaluation of the lighting conditions, comparisons of the various characteristics to desired levels are performed (608). For example, threshold levels of light may be desired for a satisfactory image. Additionally, evenness in lighting and color balance may be desired. Further, maximum light levels are checked against to determine if the image is oversaturated or otherwise too bright. In response to determine adjustments are needed (610) in order to change the lighting conditions, a light border is generated (612) (or altered if one has already been generated) in order to compensate for lighting conditions that don't meet desired levels.

For example, if lighting conditions are deemed too low (e.g., below a threshold level), then a light border is generated for display on a display device. The light border is generated with a size/width, color, and pixel brightness in dependence on the current lighting conditions. If the lighting conditions are significantly below a threshold level, then the border is generated in a manner that it produces more light. This is accomplished by generated the border to be larger (e.g., have a greater width), having a brighter color (e.g., white as opposed to a darker color light blue or brown), and with a high level of pixel brightness. Current lighting conditions that are not determined to be significantly below the threshold level result in generation of a light border that does not produce as much light (i.e., not as much light is needed). In the event that the current lighting conditions are deemed too bright, then an existing generated light border is adjusted to produce less light.

If no light border is currently being generated and the lighting conditions are still deemed to bright, then the image data may be adjusted to reduce exposure levels or other image processing may be performed. If lighting is uneven, then a light border is generated such that it produces more light on the side or portion of the image deemed to have lower light levels than other portions. For example, based on the evaluation at 606, an illumination map is generated that indicates relative light levels of portions of the image. Based on this map, a light border is generated to compensate for portions of the map that indicate lower light levels. Based on the above discussed feedback and reevaluation, the process attempts to even out lighting conditions as indicated by the map. Subsequent to determining the light border to be generated or otherwise adjusted (612), the final display image is generated and conveyed for display on the display device (614).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
an evaluation unit configured to receive image data captured by a camera; and
a border generation unit configured to automatically generate a light border as part of display image data, responsive to determined light levels in the image data.

2. The apparatus as recited in claim 1, wherein the light border is generated with light levels to compensate for light levels deemed low in the image data.

3. The apparatus as recited in claim 2, wherein the light border comprises a plurality of pixels generated with a number and brightness level in dependence on the image data.

4. The apparatus as recited in claim 1, wherein the border generation unit is configured to generate a composite image including the light border and video image data captured by the camera.

5. The apparatus as recited in claim 4, wherein the video image data is received from a video conference application.

6. The apparatus as recited in claim 1, wherein the evaluation unit is configured to determine exposure levels of the image data.

7. The apparatus as recited in claim 6, wherein the evaluation unit is configured to identify a subject within the image data.

8. The apparatus as recited in claim 6, wherein the evaluation unit is configured to convey an illumination map indicating relative levels of brightness of the image data to the border unit.

9. The apparatus as recited in claim 1, wherein the border unit is configured to generate the light border with an asymmetric brightness level.

10. A method comprising:
receiving image data captured by a camera; and
automatically generating a light border as part of display image data, responsive to determined light levels in the image data.

11. The method as recited in claim 10, further comprising generating the light border with light levels to compensate for light levels deemed low in the image data.

12. The method as recited in claim 11, further comprising generating the light border with pixels that have a number and brightness level in dependence on the image data.

13. The method as recited in claim 10, further comprising generating a composite image including the light border and video image data captured by the camera.

14. The method as recited in claim 13, further comprising receiving the video image data from a video conference application.

15. The method as recited in claim 10, further comprising determining exposure levels of the image data.

16. The method as recited in claim 15, further comprising identifying, by an evaluation unit, a subject within the image data.

17. The method as recited in claim 16, further comprising generating an illumination map indicating relative levels of brightness of the image data.

18. The method as recited in claim 10, further comprising generating the light border with an asymmetric brightness level.

19. A system comprising:
a camera configured to capture image data;
a display device; and
a computing device, wherein the computing device is configured to:
receive image data captured by the camera; and
automatically generate a light border as part of an image displayed on the display device, responsive to determined light levels in the image data.

20. The system as recited in claim 19, wherein the light border comprises a plurality of pixels generated with a number and brightness level in dependence on the image data.
